(19) United States
(12) Patent Application Publication
(10) Pub. No.: US 2019/0193646 A1
(43) Pub. Date: Jun. 27, 2019

(54) AUTOMOTIVE CAMERA SYSTEM

(71) Applicant: FICOSA NORTH AMERICA CORPORATION, Madison Heights, MI (US)

(72) Inventor: Damon Paul BLAICHER, Royal Oak, MI (US)

(21) Appl. No.: 15/852,456

(22) Filed: Dec. 22, 2017

(51) Int. Cl. B60R 11/04; H04N 7/18; B60R 1/00; B60R 16/023; H04N 5/232

(52) U.S. Cl. CPC B60R 11/04; H04N 7/18; B60R 2300/406; B60R 16/023; H04N 5/23238; B60R 1/00

(57) ABSTRACT

A selectively installable camera system for portable use on a vehicle, the camera system may include at least one camera assembly configured to selectively attach to the vehicle, at least one vehicle head-unit having a display and configured to display an authentication image for capture by the camera assembly and communicate with the camera assembly via a wireless network upon pairing of the camera assembly with the head-unit in response to authentication of the image at the camera assembly.

### TECHNICAL FIELD

Disclosed herein are automotive cameras and automotive camera systems.

### BACKGROUND

Vehicles are often equipped with cameras, specifically exterior cameras. These cameras may provide a field of view of an exterior of the vehicle to an interior user interface to aid the driver in parking the vehicle. Data from the camera may be transmitted to the interior user interface via a wireless network.

### SUMMARY

A portable camera assembly for temporary installation on a vehicle may include a camera including a lens and sensor and a camera processor configured to receive image data from the camera. The assembly may further include a communication component configured to transmit the image data to a vehicle head-unit for display thereon, and a mounting element configured to selectively attach the camera assembly to the vehicle.

A portable camera system for selective installation on a vehicle, the camera system may include a camera including a lens and sensor and a camera processor configured to receive image data from the camera. The system may further include an antenna configured to wirelessly communicate with a vehicle head-unit upon installation on the vehicle.

A selectively installable camera system for portable use on a vehicle, the camera system may include at least one camera assembly configured to selectively attach to the vehicle. The system may also include at least one vehicle head-unit having a display and configured to display an authentication image for capture by the camera assembly and communicate with the camera assembly via a wireless network upon pairing of the camera assembly with the head-unit in response to authentication of the image at the camera assembly.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example camera system for a vehicle;

FIG. 2 illustrates an example camera assembly of the camera system;

FIG. 3 illustrates a block diagram of the example camera assembly;

FIG. 4 illustrates an example diagram of a pairing process between the vehicle and the camera assembly; and

FIG. 5 illustrates an example process for the camera assembly.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicles are often equipped with cameras to aid in viewing areas surrounding the vehicles, as well as areas within the vehicle. These cameras may be integrated within the vehicle and configured to draw power from the vehicle's power supply, such as the vehicle's battery. These cameras may also communicate with the vehicle via a communication system within the vehicle. Often times additional cameras are desired for additional viewing areas, such as a rear seat of the vehicle or a rear exterior of the vehicle to view a towable item such as a trailer. However, after-market cameras are difficult to integrate with existing vehicle systems, can require a central communication module just for the cameras, can be costly to install, and can fail to provide sufficient quality images. Many of these systems have limited transmission distances, lack image quality, require a wired power source, require an additional mobile device application to be downloaded in order to synchronize with a vehicle head-unit, require an additional display in addition to the existing center stack display, etc.

Disclosed herein is a vehicle camera system having at least one camera assembly configured to be selectively installed in or on a vehicle. The camera assembly may have a separate communication component capable of interfacing with vehicle processors for easy pairing between the two devices. The camera assembly may be easily installed and removed so as to be movable from one location on a vehicle to another, and between multiple vehicles, trailers, etc. The camera assembly may be mounted on an exterior or an interior of the vehicle, and multiple mounting options are included in the assembly. The assembly may include a higher quality antenna to facilitate wireless communication between the camera assembly and the vehicle processor. The camera may also include a portable power source such as a battery. Due to the ease of set-up, this camera assembly may be easily configurable and desirable for aftermarket, factory installed, and factory invoiced markets. Thus, an easily configurable camera assembly is provided that increases the quality of images and communication, as well as allows for a user-friendly and less costly installation.

Multiple camera assemblies may be simultaneously used by the camera system and each may be connected with the vehicle processor and head-unit. A switchable view may be permitted at a display at the head-unit to provide a user with multiple viewing options and areas.

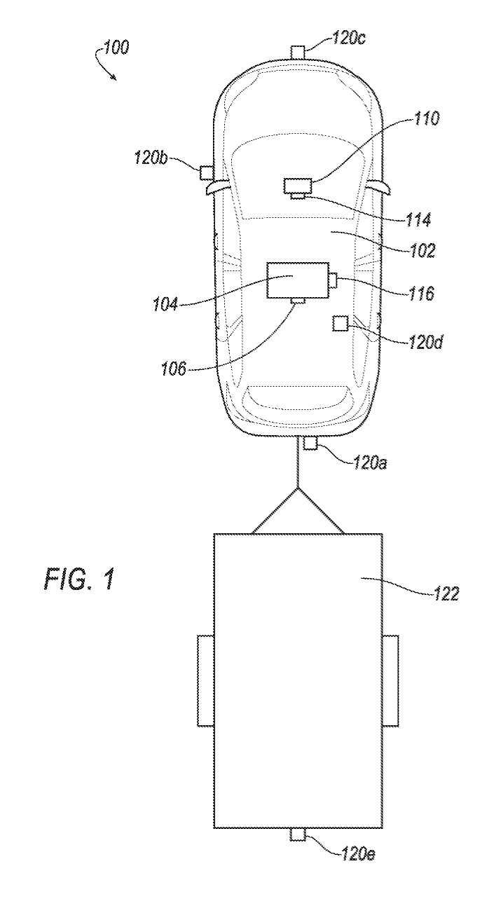

FIG. 1 illustrates an example camera system 100 for a vehicle 102. The vehicle 102 is illustrated as a car or sedan, but may be any motor passenger vehicle including but not limited to a truck, sport utility vehicle, cross-over, hatchback, station wagon, motorcycle, all-terrain vehicle (ATV), recreational vehicle (RV), boat, plane or other mobile machine for transporting people or goods, etc. The vehicle 102 may include a vehicle processor 104 configured to execute instructions of various vehicle applications. These applications may provide features to the vehicle 102 such as navigation, control of various vehicle systems such as climate, mirrors, windows, locks, entertainment, etc. The processor 104 may be in communication with a memory 106. The memory 106 may be a computer-readable storage medium that includes any non-transitory medium (e.g., a tangible medium) and provides instructions or other data that may be read by the processor 104.

The vehicle 102 may include a head-unit 110. The processor 104 and memory 106 may be embodied in the head-unit 110. The head-unit 110 may include a display 114. The display 114 may be arranged within the vehicle dash board or center console. The display 114 may also include a heads up display (HUD). The display 114 may include a user interface (not separately shown), configured to receive user input. The display 114 may be configured to present information, images, and options to a passenger of the vehicle 102. Specifically, the display 114 may be configured to receive image data from one or more vehicle cameras and present images to the driver.

The processor 104 may include a wireless transceiver 116. The transceiver 116 may be a wireless radio configured to receive and transmit images and/or communications wirelessly with other compatible devices, such as a camera assembly 120, described herein. The transceiver 116 may be for example, a BLUETOOTH module, a ZIGBEE transceiver, a WiFi™ transceiver, an IrDA transceiver, an RFID transceiver, etc. The transceiver 116 may create a wireless network between the processor 104 and the camera assembly 120 in order to receive images wirelessly from the camera assembly 120. While the transceiver 116 is shown as being with the processor 104, the transceiver 116 may be embodied within the head-unit 110. Similarly, the head-unit 110 may include the processor 104, or may be in communication with the vehicle processor 104. More than one transceiver 116 may be included within the vehicle 102. The vehicle 102 may also include one or more antennas, communication networks, etc.

The camera system 100 may include at least one camera assembly 120 configured to capture images. As shown by way of example in FIG. 1, the at least one camera assembly 120 may include a plurality of camera assemblies 120a-e (collectively and singularly referred to herein as camera assembly 120 and camera assemblies 120). The camera assemblies 120 may be arranged around the exterior of the vehicle 102, around the exterior of a trailer 122, within the interior of the vehicle 102, and/or within the interior of the trailer 122. The camera assemblies 120 arranged on the exterior of the vehicle 102 may provide images to the passenger regarding events and objects surrounding the vehicle 102. For example, the images may aid in providing guidance during parking. The images may also aid in backing the vehicle 102 into alignment with the trailer 122.

The interior camera assemblies 120 may provide images relating to the interior of the vehicle 102. In one example, the camera assemblies 120 may be arranged to view a rear seated child seat. The images from the camera assembly 120 may provide a visual to the driver of the child in the backseat. This may be especially helpful to parents as rear-facing child restraint systems are being used more frequently and for a longer duration.

Specific examples of the plurality of camera assemblies 120 may include a rear back-up camera 120a, a side mirror camera 120b, a front camera 120c, an interior vehicle camera 120d, and a rear trailer camera 120e. These examples are just that, and camera assemblies 120 may be arranged at a plurality of other locations around, in and on the vehicle 102 and trailer 122.

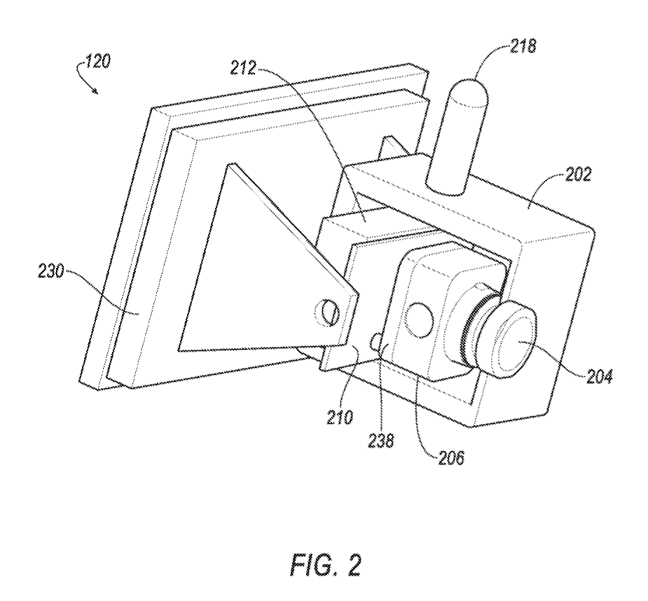

The camera assembly 120 is described in more detail with respect to FIG. 2. The camera assembly 120 may communicate with the processor 104 within the vehicle 102 via the wireless network to supply captured image data to the processor 104. The processor 104 may in turn display images based on the image data at the display 114.

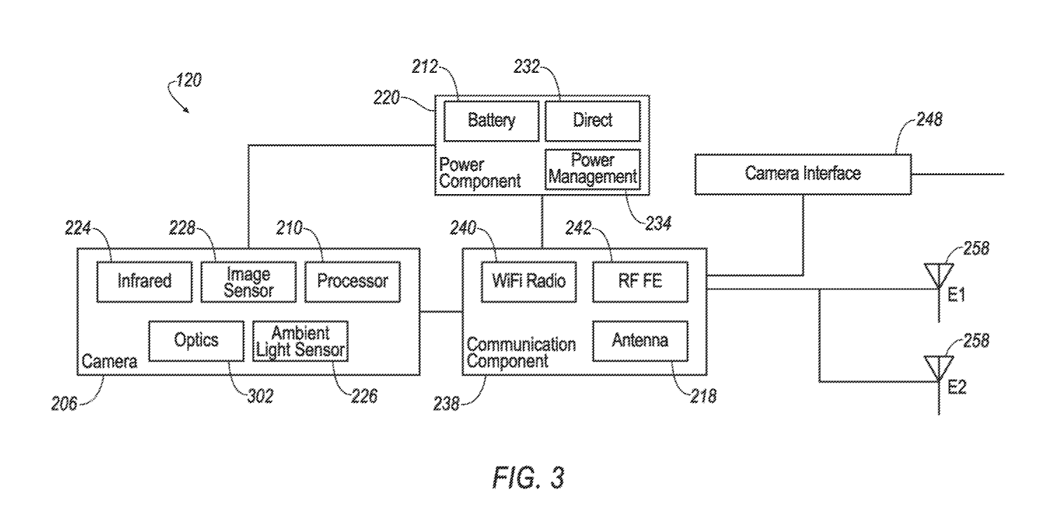

FIG. 2 illustrates an example camera assembly 120. The camera assembly 120 may include a housing 202 for maintaining the various components of the camera assembly 120. The camera assembly 120 may include a camera 206 having a lens 204. The lens 204 may have a field of view (FOV) that allows for a panoramic view of the field in front of the lens 204. For example, the lens 204 may have a 160 degree FOV. The camera 206 may be capable of capturing images and video at a resolution of 1280×1080, and a frame rate of 30 frames per second, for example. The camera 206 may he an ethernet camera. The camera 206 may include a camera processor 210 and an image sensor 228 (as shown in FIG. 3). The camera assembly 120 may include a battery 212. The battery 212 may be a Li-ion battery configured to provide power to the camera assembly 120 and may be removeable. The battery 212 may meet stringent thermal requirements in order to meet or exceed automotive specifications and have an improved lifespan.

The camera assembly 120 may include an antenna 218 configured to transmit and receive wireless communications. The antenna 218 may be external, as illustrated by way of example in FIG. 2. Additionally or alternatively, the antenna 218 may be internal to the housing 202.

The antenna 218 may interface with a communication component 238 to transmit and receive wireless communications. Camera assembly 120 may communicate with the transceiver 116 within the vehicle 102. The communication component 238 may be a Wi-Fi interface DCIO 3.0, a BLUETOOTH UART 802.11 operating at a 5 Ghz or 2.4 Ghz LAN protocol, for example. The antenna 218 may have a wide range, such as at least 70 feet. The communication component 238 is discussed in further detail below with respect to FIG. 3.

The camera assembly 120 may include a mounting portion 230, or mounting element, configured to attach to various exterior and interior components of the vehicle 102. In one example, the mounting portion 230 may include an attachment mechanism such as a suction-cup configured to adhere to a smooth surface. In another example, the mounting portion 230 may include an attachment mechanism such as an adhesive. In another example, the mounting portion 230 may include magnetic attachment points. In still another example, the mounting portion 230 may include standard, or non-standard, bolt and receiving threaded receptacle.

The mounting portion 230 may affix the camera assembly 120 to the vehicle 102 in either a permanent or semi-permanent manner. Additionally or alternatively, the mounting portion 230 may temporarily affix the camera assembly 120 to the vehicle 102, allowing for the camera assembly 120 to be easily removable. In this example, the camera assembly 120 may be easily moved from one location on the vehicle 102 to another. For example, in one situation the driver may wish to affix the camera assembly 120 to the interior of the vehicle 102, facilitating a view of a rear seat. In another example, and during a subsequent trip, the driver may wish to affix the camera assembly 120 to an exterior of the trailer 122. Additionally, at certain times, the driver may wish to not use the camera assembly 120 and simply remove the assembly 120 from the vehicle 102. The camera assembly 120 may be installed and removed as desired, and even moved from one vehicle 102 or trailer 122 to another.

FIG. 3 illustrates a block diagram of the example camera assembly 120. As explained, the camera assembly 120 may include the camera 206. The camera 206 may include various components to aid in the operation of the camera both in light and dark. The camera 206 may include various optics 302, such as the lens 204. The camera 206 may also include an infrared component 224, which may include an infrared LED configured to provide low light or “night vision” for the camera 206 and an ability to cut the existing IR filter out of the light path within the lens assembly 204. An ambient light sensor 226 may detect the ambient light and allow the lens 204 and the infrared component 224 to react accordingly in response to commands provided by the camera processor 210. The image sensor 228 may capture images and light. The camera processor 210 may receive images from the image sensor 228. The processor 210 may then instruct the antenna 218 (as shown in FIG. 2) to transmit image data including the image. The image sensor 228 may, for example, be a 2.0 mega pixel (MP) sensor.

The camera assembly 120 may include a power component 220 configured to provide power to the camera assembly 120. The power component 220 may include various forms of power supplies such as the battery 212 and/or a direct power source 232, such as a wired AC power supply. The power component 220 may include a power management processor 234 configured to manage power supply. For example, the power management processor 234 may determine when to power the camera assembly 120 and when to not power the camera assembly 120. This may include powering down the assembly 120 during non-use (e.g., during non-drive times). The processor 234 may also determine to supply power during certain drive situations. For example, the processor 234 may elect to power the assembly 120 while the vehicle 102 is backing up, thus permitting the camera assembly 120 to provide imaging during this maneuver. The processor 234, in another example, may elect to power the assembly 120 when the vehicle 102 is in drive, but not when the vehicle 102 is in park.

The battery 212 may be rechargeable. The battery 212 may be recharged by an external power supply and may include a USB charging port at an interface 248.

The camera assembly 120 may further include the communication component 238. This may include the antenna 218. The communication component 238 may also include a WiFi™ Radio component 240 and a radio frequency front end (RF FE) component 242. The WiFi™ radio component 240 may facilitate communication between the vehicle processor 104 and the camera assembly 120 via WiFi™ communication protocols. The communication component 238 may interface with various antennas 258.

The RF FE component 242 may be configured to receive and process signals and provide the signals to the antenna 218. For example, the WiFi™ radio component 240 may implement the Institute of Electrical and Electronics Engineers (IEEE) 802.11.ac standard for communication and additionally allowing for communication via older 802.11 protocols including 802.11g and 802.11n. This standard permits beamforming which will in turn allow for long transmission distances at high bandwidths, allowing the camera assembly 120 to transmit image data at much greater distances than typical assemblies. The communication component 238 may also facilitate BLUETOOTH 5.0 technology to communicate with the vehicle processor 104. This may allow for improved audio/visual transmission distances, authentication, and increased image quality.

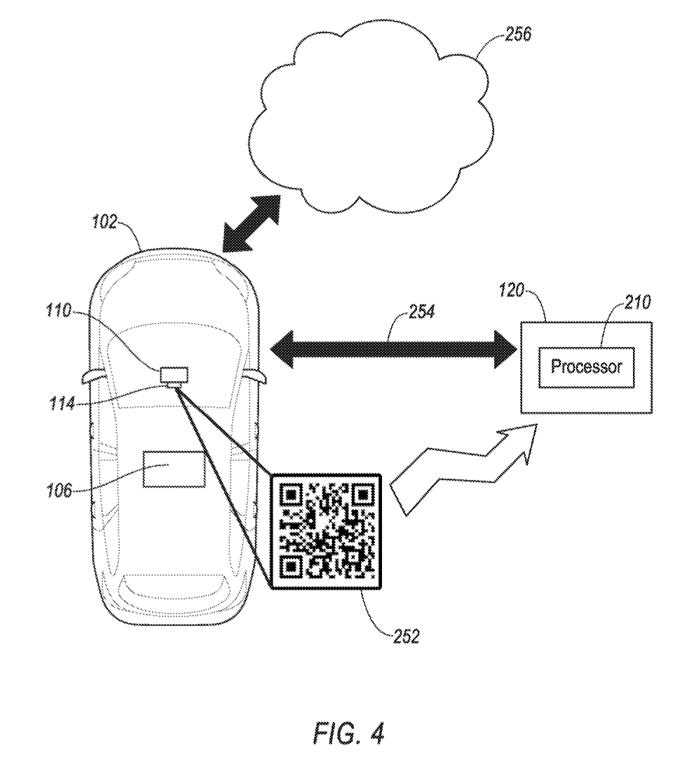

FIG. 4 illustrates an example diagram of a pairing process between the vehicle 102 and the camera assembly 120. Upon set-up, the vehicle 102 and the camera assembly 120 may be paired in order to create a communication network between the vehicle 102 and the camera assembly 120. The communication network may be specific to the camera assembly 120 and the vehicle 102 to provide a secure transmission of data between the two components. The camera assembly 120, as explained, may be an after-market device configured to provide a portable and integratable camera for vehicles. In doing this, the camera assembly 120 may be paired with the vehicle 102 on an as-needed basis.

The vehicle head-unit 110 may, via the vehicle processor 104, include a software configured to provide various credentials. These credentials may include a vehicle specific two-dimensional code 252 or authentication image, such as a QR code, bar code, etc. The example vehicle code 252 shown in FIG. 4 includes a QR code. The vehicle code 252 may be stored in the memory 106 of the vehicle 102 and may be presented via the display 114. Additionally or alternatively, the vehicle code 252 may be maintained in a computing cloud 256, external server, a user's mobile device, etc. The display 114 may present the vehicle code 252 to the user.

During the initial set up, the user may place the camera assembly 120 in front of the display 114. The user may turn on the camera assembly 120, and capture an image of the vehicle code 252. The camera processor 210 may process the code 252 and use the code 252 to identify the vehicle 102.

Upon receiving the vehicle code 252, the camera assembly 120 may initiate pairing with the vehicle 102 via a wireless network 254. The wireless network 254 may be a WiFi™ network, BLUETOOTH, WLAN, etc. Security and encryption may be implemented via a WiFi™ protection setup (WPS) or WiFI Protected Access II (WPA-2). The camera may have the ability to act as an access point or the client to ensure that data transmitted over the wireless network 254 is secure and undetectable by third parties.

Notably, the camera system 100 may include multiple camera assemblies 120 which use the wireless network 254 supplied by the vehicle 102. The camera assemblies 120 may also interface directly with the vehicle processor 104 instead of having a central processor for just the camera assemblies 120. This allows for greater flexibility of installation locations, interchangeability within the camera system 100, etc. The camera assemblies 120 may be easily moved from one location to the next, and from one vehicle, trailer, etc., to another.

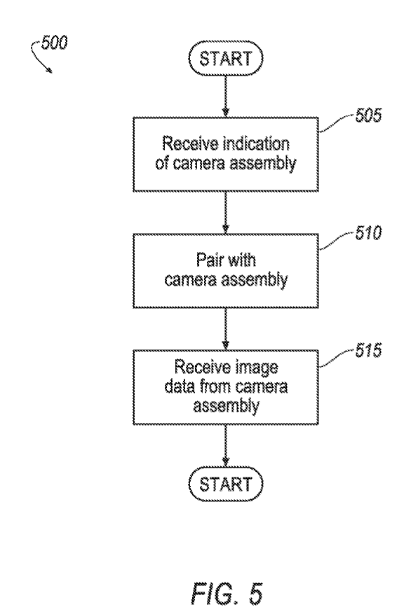

FIG. 5 illustrates an example process 500 for the camera assembly 120. As explained, vehicle head-unit 110 may, via the vehicle processor 104, include a software configured to pair the camera assembly 120 with the head-unit 110. The process 500 begins at block 505 where the head-unit 110 may receive an indication of the presence of a camera assembly 120. Such presence may be indicated by user interaction at the display 114. In another example, the presence of the camera assembly 120 may be recognized by receipt of a wireless inquiry over the wireless network 254.

At block 510, the head-unit 110 may pair with the camera assembly 120 via the processes as described above with respect to FIG. 4.

At block 515, once the camera assembly 120 is paired with the head-unit 110, the head-unit 110 may receive image data from the camera assembly 120 via the wireless network 254. The process 500 may continue until the camera assembly 120 is removed from the vehicle 102. The camera assembly 120 may he temporarily attached to the vehicle 102, as well as be moved from one vehicle to another.

Computing devices described herein generally include computer-executable instructions, where the instructions may be executable by one or more computing or hardware devices, such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. in general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A portable camera assembly for temporary installation on a vehicle, the camera assembly, comprising:
a camera including a lens and sensor;
a camera processor configured to receive image data from the camera;
a communication component configured to transmit the image data to a vehicle head-unit for display thereon; and
a mounting element configured to selectively attach the camera assembly to the vehicle.

2. The assembly of claim 1, wherein the mounting element includes at least one attachment mechanism configured to attach the camera assembly to both an interior of the vehicle and an exterior of the vehicle.

3. The assembly of claim 3, wherein the attachment mechanism includes at least one of an adhesive, a magnetic portion, a bolt, and a suction cup.

4. The assembly of claim 1, wherein the camera processor is configured to communication with the vehicle head-unit via a wireless network between the camera assembly and the vehicle.

5. The assembly of claim 4, wherein the wireless network includes a WiFi radio configured to implement the Institute of Electrical and Electronics Engineers (IEEE) 802.11 standard.

6. The assembly of claim 1, wherein the camera processor is configured to receive an authentication image from the camera captured from the vehicle head-unit, the camera processor further configured to initiate pairing of the camera with the vehicle head-unit based on the authentication image.

7. The assembly of claim 6, wherein the authentication image includes a two dimensional code.

8. The assembly of claim 1, further comprising a portable power supply configured to power the camera assembly without a wired connection to the vehicle.

9. A portable camera system for selective installation on a vehicle, the camera system, comprising:
a camera including a lens and sensor;
a camera processor configured to receive image data from the camera; and
an antenna configured to wirelessly communicate with a vehicle head-unit upon installation on the vehicle.

10. The system of claim 9, further comprising a mounting element configured to selectively attach the camera assembly to the vehicle.

11. The system of claim 10, wherein the mounting element includes at least one of an adhesive, a magnetic portion, a bolt, and a suction cup.

12. The system of claim 10, wherein the antenna is configured to communicate with the head-unit via the institute of Electrical and Electronics Engineers (IEEE) 802.11ac standard.

13. The system of claim 10, wherein the camera processor is configured to receive an authentication image from the camera captured from the vehicle head-unit, the camera processor further configured to initiate pairing of the camera with the vehicle head-unit based on the authentication image.

14. The assembly of claim 13, wherein the authentication image includes a two dimensional code.

15. The assembly of claim 10, further comprising a portable power supply configured to power the camera assembly without a wired connection to the vehicle.

16. A selectively installable camera system for portable use on a vehicle, the camera system, comprising:
at least one camera assembly configured to selectively attach to the vehicle;
at least one vehicle head-unit having a display and configured to:
display an authentication image for capture by the camera assembly;
communicate with the camera assembly via a wireless network upon pairing of the camera assembly with the bead-unit in response to authentication of the image at the camera assembly.

17. The system of claim. 16, wherein the at least one camera assembly includes a plurality of camera assemblies, each configured to communicate with the head-unit via the wireless network without a central communication module for the camera assemblies.

18. The system of claim 16, wherein the at least one camera assembly includes an antenna configured to communicate with the head-unit via the Institute of Electrical and Electronics Engineers (IEEE) 802.11ac standard.

19. The system of claim 16, wherein the authentication image includes a two dimensional code.

20. The assembly of claim 16, wherein the at least one camera assembly includes a portable power supply configured to power the camera assembly without a wired connection to the vehicle.
